(19) United States
(12) Patent Application Publication
(10) Pub. No.: US 2006/0069796 A1
(43) Pub. Date: Mar. 30, 2006

(54) Method for automatic patching of a sparsely streamed application

(75) Inventors: Todd C. Lucas, Woodinville, WA (US); Jesse P. Roberts, Seattle, WA (US)

Correspondence Address: DARBY & DARBY P.C., P. O. BOX 5257, NEW YORK, NY, 10150-5257, US

(73) Assignee: Infinium Labs, Inc., Sarasota, FL (US)

(21) Appl. No.: 10/953,313

(22) Filed: Sep. 29, 2004

(51) Int. Cl. G06F 15/16

(52) U.S. Cl. 709/231

(57) ABSTRACT

A method and apparatus are provided for automatic patching of a sparsely streamed application, such as a game application. The invention enables an initial file set to be streamed to a client's network device. The file set is used to generate file segments. A patcher is then authorized to write to sections of the file segment, regardless of whether they have received portions of the streamed application. Once a section of the file segment has been written to by the patcher, that section becomes an authoritative region, which indicates that the streaming process may not write to it again. This authoritative region represents a last-known good image for that section of the file. This approach may be applied over an arbitrary number of patches, with authoritative sections growing, coalescing, or truncating as appropriate.

### FIELD OF THE INVENTION

The invention relates generally to streaming content over a network, and more particularly but not exclusively to an apparatus and method for providing automatic patching of a sparsely streamed application, such as a game application.

### BACKGROUND OF THE INVENTION

Internet streaming of content has changed the Web as we knew it from a static text and graphics medium into a multimedia experience surrounded with sound and moving pictures. Streaming content may be poised to become a de facto distribution standard, incorporating virtually all other media, including television, radio, and movies. The low cost and technical simplicity of streaming content makes web broadcasting irresistible to publishers, broadcasters, corporations, and individuals.

This technology enables a website user to merely click on a selection and moments later to listen to music, watch a movie, attend an educational program, and even to play an interactive computer game. Streaming typically works by first compressing a digital file and then decomposing it into smaller packets, which may then be transported over a network, such as the Internet. When the packets reach a destination, they are decompressed and reassembled into a form that can be played by the user's system. Often the packets are buffered on the user's system so a number of them are downloaded to the user's system before playback. As the buffered or preloaded packets play, more packets are being downloaded and queued up for playback.

Streaming of computer game applications has been particularly successful. A user may simply install a client player component, which lets the user stream and play the game application over a network connection, often with only a small portion of the game content having been downloaded first. As the user progresses through parts of the game, additional levels, and other data may be seamlessly downloaded in the background so they're there when the game application may need them.

However, many game applications, and other applications, are routinely patched or updated when the application is launched on the user's system, and prior to play. Such patches may be directed towards correcting programming errors, providing enhanced features, customizing the application to the user's system, patching security flaws, incorporating anti-cheat features, and the like. Because traditional patching approaches may assume the presence of the application, patching presents a challenge to the design of streaming applications. Thus, it is with respect to these considerations and others that the present invention has been made.

### BRIEF DESCRIPTION OF THE DRAWINGS

Non-limiting and non-exhaustive embodiments of the invention are described with reference to the following drawings. In the drawings, like reference numerals refer to like parts throughout the various figures unless otherwise specified.

For a better understanding of the invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a client device that may be employed in a system implementing the invention;

FIG. 3 illustrates a logical flow diagram generally showing one embodiment of a process for streaming an automatic patching application; and

FIG. 4A-D show one embodiment of a file segment of an application during an automatic patching process, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards a method and apparatus for providing automatic patching of a sparsely streamed application. In one embodiment, the streamed application is an interactive computer game. However, the invention is not so limited, and the invention may be applied to virtually any application that may be streamed.

The invention considers each file segment as a layer of file segments. A file segment may include either an original file that is being streamed over a network, or file section information that is associated with a given patch.

The invention then enables an initial file segment to be streamed to a client's network device. As part of an initialization activity, an empty file segment may be allocated to receive at least a portion of the streamed application. A patcher is then authorized to write to sections of the file segment, regardless of whether a portion of the streamed application has been written into the file segment. Once a section has been written to by the patcher, that section becomes an authoritative section for a region of a file segment. When the patcher writes to the file segment, the original file-set layer for that section becomes marked as invalid, which indicates that the streaming application process may not write to it again. This authoritative section then represents a last-known good image for that section of the file segment. The above approach may be applied over an arbitrary number of patches, with authoritative sections growing, coalescing, or truncating as appropriate.

Additionally, once the file segment that has been patched has been completely streamed, it may be hashed. The resulting hash value may then be compared against another hash-value associated with that file in a patch file-set meta-data. Some hash operations may assume that the entire streamed application is streamed onto the client in order to scan the streamed application to generate a hash value. However, the invention may accommodate such restrictions, through a variety of mechanisms. For example, in one embodiment, hash values may be generated to include file segments that are still on the server (e.g., not yet streamed to the client).

Illustrative Operating Environment

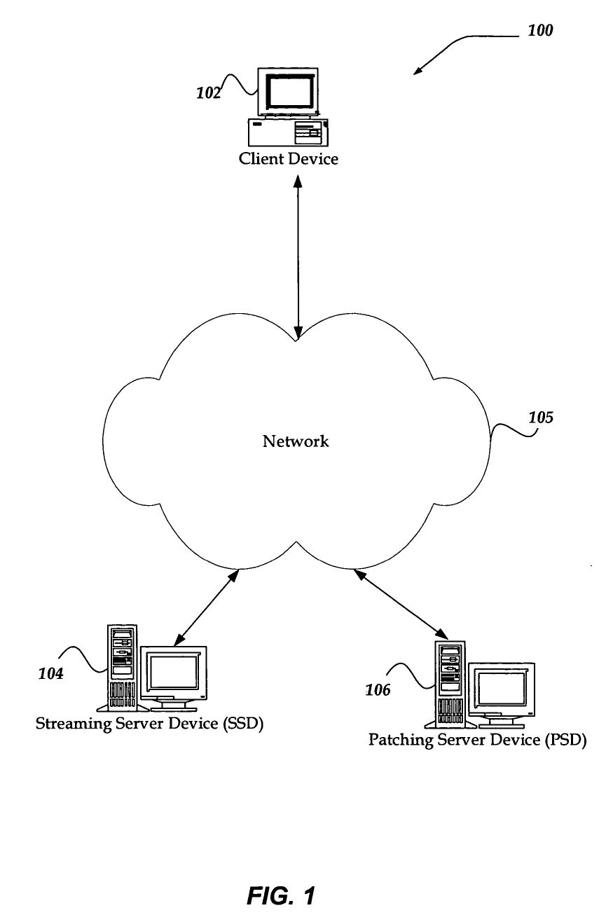

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, a system 100 includes client device 102, network 105, streaming server device (SSD) 104, and patching server device (PSD) 106. Network 105 is in communication with and enables communication between each of client device 102, SSD 104, and PSD 106.

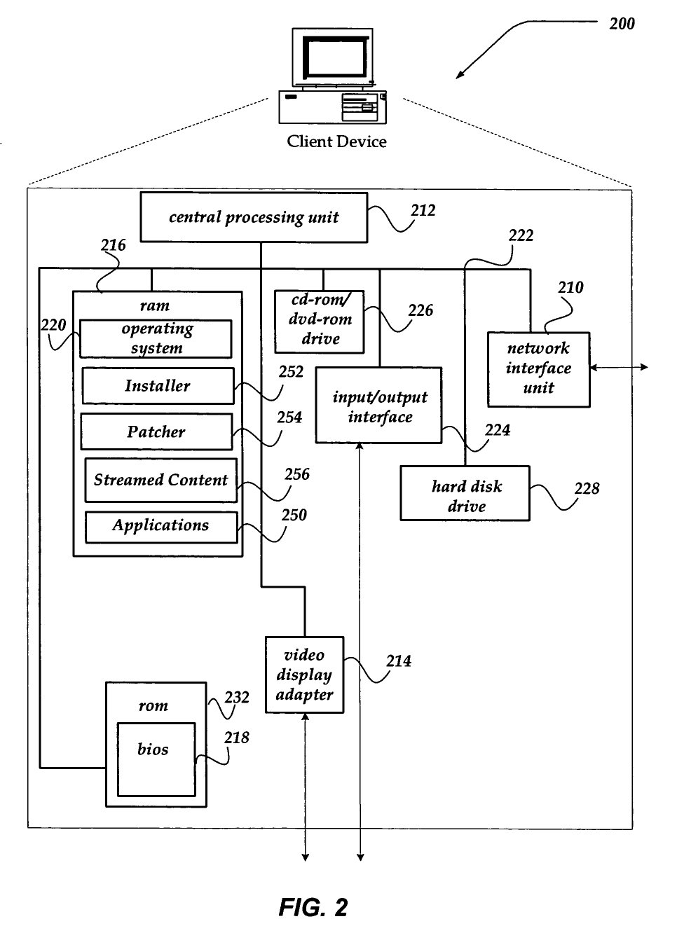

One embodiment of client device 102 is described in more detail below in conjunction with FIG. 2. Briefly, however, client device 102 may include virtually any computing device capable of receiving a streamed application over a network, such as network 105, from another computing device, such as SSD 104, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie-talkies, radio frequency (RF) devices, infrared (IR) devices, CBs, integrated devices combining one or more of the preceding devices, or virtually any mobile device, and the like. Similarly, client device 102 may be any device that is capable of connecting using a wired or wireless communication medium such as a PDA, POCKET PC, wearable computer, and any other device that is equipped to communicate over a wired and/or wireless communication medium.

Client device 102 may be configured to receive the streamed application employing any of a variety of mechanisms, including, User Datagram Protocol (UDP)/Internet Protocol (IP), RealTime Streaming Protocol (RTSP), HyperText Transfer Protocol (HTTP), and the like. Moreover, client device 102 may include a client application that is enabled to use a variety of formats for managing the streaming application, including, RealAudio, streaming MP3, Flash, Shockwave, Windows Media, QuickTime, RealMedia G2 with SMIL, Rich Music Format (RMF), Liquid Audio, MP3, MIDI, WAV, AU, and the like. In one embodiment, client device 102 employs the client application to communicate with a streaming server device, such as SSD 104, to negotiate and receive the streaming application.

Client device 102 may be further configured to receive additional content, such as a patch to the streamed application, from another computing device employing a similar or different mechanism than above. In one embodiment, client device 102 employs the client application to communicate with a patching server device, such as PSD 106, to negotiate and receive the patch to the streamed application.

The streamed application may include virtually any computer content that may be streamed over a network, such as network 105, including a game application, music, videos, graphical files, interactive files, educational programs, audio files, news, advertisements, and the like.

Network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links. Furthermore, remote computers and other related electronic devices could be remotely connected to either LANs or WANs via a modem and temporary telephone link. In essence, network 105 includes any communication method by which information may travel between client device 102, SSD 104, and PSD 106.

The media used to transmit information in communication links as described above illustrates one type of computer-readable media, namely wired and/or wireless communication media. Generally, computer-readable media includes any media that can be accessed by a computing device. Computer-readable media may include computer storage media, communication media, or any combination thereof. Additionally, communication media typically embodies computer-readable instructions, data structures, program modules, or other data in a modulated data signal such as a carrier wave or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

SSD 104 may include any computing device capable of connecting to network 105 to communicate information to client device 102, such as a streamed application. Devices that may operate as SSD 104 include personal computers desktop computers, multiprocessor systems, microprocessor-based or programmable consumer electronics, network PCs, servers, and the like. SSD 104 and client device 102 can be arranged in a client-server relationship relative to each other. Client device 102 can also be combined with SSD 104 in virtually any other computing architecture, including, but not limited to a peer-to-peer architecture, and the like, without departing from the scope of the present invention.

Similarly, PSD 106 may also include virtually any computing device capable of connecting to network 105 to communicate information to client device 102, such as a patch to an application streamed from SSD 104. Devices that may operate as SSD 104 include personal computers desktop computers, multiprocessor systems, microprocessor-based or programmable consumer electronics, network PCs, servers, and the like. Although FIG. 1 illustrates SSD 104 and PSD 106 as distinct devices, the invention is not so limited. For example, PSD 106 and SSD 104 may co-exist as a single computing device configured to provide both the streamed application and the patch to the application.

Illustrative Client Environment

FIG. 2 shows a functional block diagram of client device 200, according to one embodiment of the invention. For example, client device 200 can comprise client device 102 of FIG. 1. Client device 200 may include many more or less components than those shown. For example, client device 200 may be configured similar to a ‘semi-thin client,’ with limited storage and application execution capability. The components shown, however, are sufficient to disclose an illustrative embodiment for practicing the invention.

Client device 200 includes a processing unit 212, a video display adapter 214, and a mass memory, all in communication with each other via a bus 222. The mass memory generally includes RAM 216, ROM 232, and one or more permanent mass storage devices, such as an optical drive 226, a hard disk drive 228, a tape drive, and/or a floppy disk drive. However, client device 200 need not include such mass storage devices and may operate substantially similar to a semi-thin client device, receiving applications across a network. The mass memory may store an operating system 220 for controlling the operation of client device 200. Any general-purpose operating system may be employed. Similarly, a proprietary operating system may also be employed. A basic input/output system (“BIOS”) 218 is provided for controlling low-level operation of client device 200. As illustrated in FIG. 2, client device 200 can communicate with the Internet, or some other communications network, such as network 105 of FIG. 1, via a network interface unit 210, which may be constructed for use with any of variety of communication protocols including, but not limited to, transmission control protocol/Internet protocol (TCP/IP), UDP/IP, HTTP, RTSP, and the like. Network interface unit 210 is sometimes known as a transceiver, transceiving device, network interface card (NIC), and the like. Client device 200 also includes input/output interface 224 for communicating with external devices, such as a mouse, keyboard, scanner, or other input devices not shown in FIG. 2.

Client device 200 may include a simple mail transfer protocol (SMTP) handler application for transmitting and receiving email. Client device 200 may also include a hypertext transfer protocol (HTTP) handler application for receiving and handing HTTP requests, and an HTTP secure sockets (HTTPS) handler application for handling secure connections. The HTTPS handler application may initiate communication with an external application in a secure fashion. Similarly, client device 200 may include a client application configured to manage a request for and a receipt of a streamed application.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, web services, security applications, transcoders, database programs, word processing programs, spreadsheet programs, and so forth. Mass storage may further include applications such as installer 252, patcher 254, and streamed content 256.

Streamed content 256 may include data for a streamed application received over a network using a streaming mechanism. Streamed content 256 may also include at least one patch of the streamed application. In one embodiment streamed content 256 is configured into streamed file segments that are of predefined lengths. Allocation of a file segment may be made prior to streaming of the actual packets for that particular file segment. As such, an allocated file segment with streamed content 256 may initially include an empty region.

Briefly, installer 252 includes any application configured to enable a delivery and playback of a streamed application, whether the streamed application includes video, audio, animation, 3-D, a panoramic image, game, or the like. Installer 252 may be configured to receive in a packet stream an initial package, which may include information about the streamed application. Such information may include, for example, a list of files that comprise the streamed application, a path name or link to each file, file identifiers associated with each file in the list, a size of each file, and so forth.

Installer 252 may be configured to employ the received information to generate at least one file segment into which at least a portion of the streamed application is to be received. As more streamed packets are received, installer 252 may enable writing of additional portions of the streamed application into the at least one file segment. Although not shown, installer 252 may include a download component that is configured to enable the additional writes of the streamed application. Additionally, installer 252 may also include a predictor component that enables a determination as to which portion of the streamed application may be employed next during execution of the streamed application, and make an appropriate request for that portion.

Patcher 254 may be invoked by installer 252, by the streamed application, or even another application (not shown), to enable a delivery of a patch of the streamed application. In one embodiment, patcher 254 is a third party application that may be obtained through a network connection, be loaded as a file segment within a portion of the streamed application, and the like.

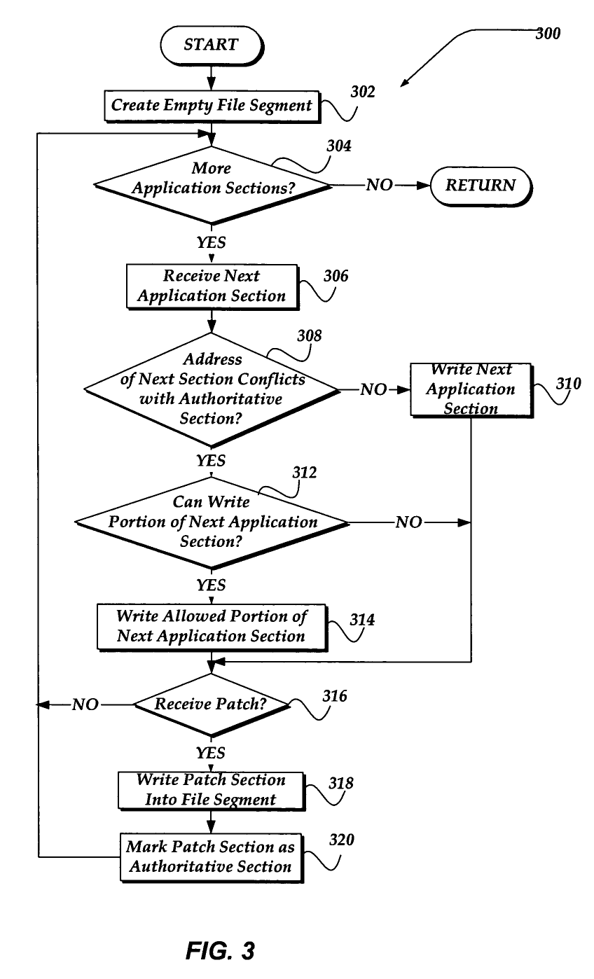

Patcher 254 may be configured to negotiate a communication with a network device for receipt of the patch. Patcher 254 may operate to write the patch into streamed content 256 at a predefined location regardless of whether streaming manager 252 has yet streamed content to that location. Patcher 254 may enable the patched section to be marked as an authoritative region. In one embodiment, patcher 254 may employ a device driver to so mark the patched section. Once the section is so marked, installer 252 is inhibited from writing into that section. In one embodiment, installer 254 and patcher 254 may employ a process substantially similar to process 300 described below in conjunction with FIG. 3 to automatically patch the streamed application.

Generalized Operation

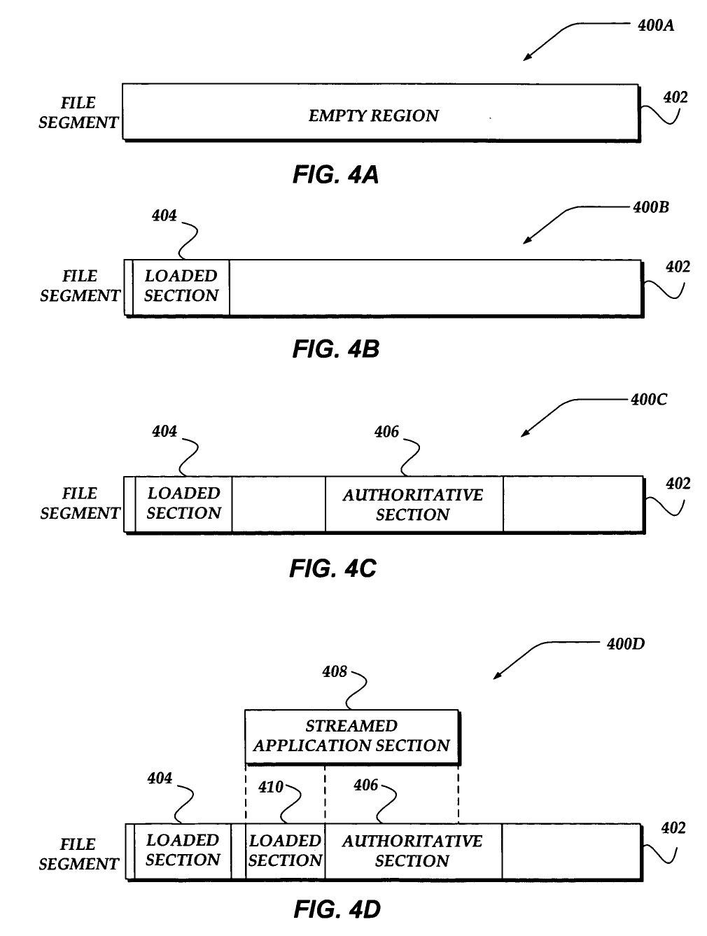

The operation of certain aspects of the present invention will now be described with respect to FIGS. 3, and 4A-C. Briefly, FIG. 3 illustrates a logical flow diagram generally showing one embodiment of a process for streaming an automatic patching application. FIGS. 4A-C are used to show an illustrative example of one embodiment of a file segment of a streamed application during the automatic patching process of FIG. 3.

Process 300 shown in FIG. 3 may be implemented, for example, within client device 102 of FIG. 1. Process 300 is typically entered when it is determined that an automatic patching of a sparsely streamed application is to be performed. An initial package may be streamed that may include a file manifest, or the like. The file manifest typically includes, as described above, a list of files associated with the streamed application, along with length information for each of the files.

Process 300 then begins, after a start block, at block 302, where the length information is employed to allocate a file segment for a first file of the application to be streamed. In one embodiment, multiple file segments may be allocated at block 302. Each allocated file segment comprises an empty region specified by a range of addresses. FIG. 4A provides an illustrative example 400A of one embodiment of empty file segment 402.

Processing then proceeds to decision block 304, where a determination is made whether a there are any streamed application sections to be written. Where this is a first entry into process 300, it is anticipated that there is at least one application section to be written into the empty file segment. If there are no more application sections, processing returns to a calling process to perform other actions. However, if there are more application sections, processing continues to block 306, where the next streamed application section is received.

Processing continues next to decision block 308 where a determination is made whether the received application section includes a range of addresses that conflicts with an authoritative section of the file segment. A conflict with the authoritative section of the file segment may be established whenever a patch section has been written into at least some of the address locations into which the received application section is also to be written. That is, there is a potential overlap in addresses. If there is not a conflict in the addresses, processing branches to block 310, where the next application section is written to the appropriate address locations of the file segment. This is illustrated in FIG. 4B by loaded section 404 within file segment 402. If however, there are conflicts with at least some of the addresses of the next application section and an authoritative section, processing branches to decision block 312.

At decision block 312, a determination is made whether there is at least a portion of the next application section that does not conflict with an authoritative section. If there is at least some addresses of the next application section that does not conflict, processing continues to block 314, where the non-conflicting address locations of the next application section are written into the file segment. In one embodiment, a device driver is employed to manage the writing and prohibition of writing into the file segment.

If, however, all of the addresses associated with the next application section conflict with an authoritative section, then, none of the next application section is written into the file segment, and processing proceeds to decision block 316. Again, the device driver may be employed to prohibit the writing of the next application section into the file segment.

At decision block 316, a determination is made whether there is a patch to be received. Typically, upon loading of a sufficient section of a predefined file segment, the streamed application may execute. Upon execution the streamed application may initiate a patcher, link to a patch site, and the like. At this juncture, the determination may be made that there isn't a patch to be received for this file segment. If there isn't a patch to be received, processing loops back to decision block 304. Otherwise, if there is a patch to be received, processing proceeds to block 318, where the patch is received, and written at an appropriate address location(s) within the file segment. During a writing of the patch, a section of the empty region of the file segment may be read by the patcher. This section may be loaded on-demand, for example, employing a normal redirector type of functionality. It is noted that a patch may actually exceed the addresses allocated for the file segment. In this instance, the patch then extends the end of file marker address location for the file segment by an appropriate length. In any event, the patch is authorized to be written to virtually any section of a file segment, whether or not that segment has already been loaded with an application section. Processing then proceeds to block 320, where the patch section is marked an authoritative section within the file segment. In one embodiment, a device driver, and the like, may be employed to so mark the patch section as authoritative. When the patcher writes to a section of the file segment, regardless of whether it has been previously written to with an application section, the original file-set ‘layer’ becomes marked as authoritative. This may be seen in FIG. 4C, where authoritative section 406 has been so marked within file segment 402. This means that a next application section may not be written into that section any longer. This is illustrated in FIG. 4D. As shown in the figure, streamed application section 408 extends into at least a portion of authoritative section 406. As described above, decision block 308, 312, and block 314, enable at least a portion of streamed application section 408 to be written into file segment 402. This portion is illustrated by loaded section 410.

Upon completing block 320, processing loops back to decision block 302 to receive more application sections and/or patch sections, until there are no more to be written. Process 300 may be applied for an arbitrary number of patch sections, within authoritative sections growing, coalescing, and/or truncating as necessary.

Upon completion of process 300, the process returns to a calling process to perform other actions. For example, in one embodiment, once a file segment that has been patched has been completely streamed, it may be hashed. Its hash-value may be compared against a predefined hash-value associated with that file segment in a patch file-set meta-data, in a file manifest, and the like.

Process 300, above, may be viewed as composed of two sub-processes, a streaming application sub-process and an authoritative or patching sub-process. The authoritative or patching sub-process of process 300 may be viewed as including blocks 316, 317, and 320. The streaming application sub-process may be viewed as including the remaining blocks of process 300. Although illustrated as an integrated process, the invention is not so limited. For example, the sub-processes may be configured to operate substantially independent of each other.

It will also be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the operations indicated in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustrations support combinations of means for performing the indicated actions, combinations of steps for performing the indicated actions and program instruction means for performing the indicated actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method of streaming an application, comprising:
generating a file segment;
writing a patch into at least one address location associated with the file segment;
marking the at least one address location that includes the patch as an authoritative section;
receiving a section of the streamed application; and
if at least a portion of the section of the streamed application is to be written into the authoritative section, prohibiting the writing of that portion of the streamed application.

2. The method of claim 1, further comprising, if another portion of the section of the streamed application is not to be written into the authoritative section, writing of the other portion of the streamed application into the file segment.

3. The method of claim 1, wherein marking the at least one address location includes employing a device driver to mark the authoritative section.

4. The method of claim 1, wherein writing the patch includes employing a patcher program.

5. The method of claim 1, further comprising, if writing the patch includes writing another address location that exceeds a length of the file segment, redefining the length of the file segment to include the other address location.

6. The method of claim 1, wherein the streamed application further comprises at least one of an application associated with RealAudio, streaming MP3, Flash, Shockwave, Windows Media, QuickTime, RealMedia G2 with SMIL, Rich Music Format (RMF), Liquid Audio, MP3, MIDI, WAV, and AU.

7. The method of claim 1, wherein the streamed application further comprises at least one of a game, music, video, graphical file, interactive file, educational program, audio file, news file, and an advertisement.

8. The method of claim 1, further comprising, determining a hash value associated with a content of the file segment, and comparing the determined hash value to a predefined hash-value.

9. The method of claim 8, determining the hash value further comprises including another hash value associated with another section of the application that has not been received.

10. A system for streaming an application, comprising:
a streaming server that is configured to stream the application; and
a client device, coupled to the streaming server, and configured to perform actions, including:
receiving, from the streaming server, a file manifest associated with the application, wherein the file manifest includes information associated with a file, and a file length value for the file;
employing the information to generate a file segment having the file length of the file;
receiving a patch associated with the application;
writing the patch into at least one address location associated with the file segment;
marking the at least one address location that includes the patch as an authoritative section;
receiving a section of the streamed application from the streaming server; and
if at least a portion of the section of the streamed application is to be written into the authoritative section, prohibiting the writing of that portion of the streamed application.

11. The system of claim 10, wherein receiving the patch includes receiving the patch from another server.

12. The system of claim 10, further comprising, if another portion of the section of the streamed application is not to be written into the authoritative section, writing of the other portion of the streamed application into the file segment.

13. The system of claim 10, wherein marking the at least one address location includes employing a device driver to mark the authoritative section.

14. The system of claim 10, wherein writing the patch includes employing a patcher program obtainable from at least one of a portion of the streamed application, and another server.

15. The system of claim 10, further comprising, if writing the patch includes writing another address location that exceeds a length of the file segment, redefining the length of the file segment to include the other address location.

16. A client device for receiving a streaming application, comprising:
a patcher that is configured to perform actions, including:
receiving a patch from a server;
enabling the patch to be written into at least one address location of a file segment; and
enabling a marking of the at least one address location that includes the patch as an authoritative section; and
an installer that is configured to perform actions, including:
generating the file segment;
receiving a section of the streamed application; and
if at least a portion of the section of the streamed application is to be written into the authoritative section, enabling a prohibition of the writing of that portion of the streamed application.

17. The client device of claim 16, wherein generating the predetermined file segment further comprises:
receiving a file manifest that comprises a list of files to be streamed and file length information for each of the files in the list of files; and
employing the list of files and file length information to generate the file segment, wherein the file segment is initially empty.

18. The client device of claim 16, wherein enabling a prohibition of the writing further comprises employing a device driver to prohibit the writing of that portion.

19. A modulated data signal for streaming an application from a server to a client, the modulated data signal comprising:
receiving at the client a patch associated with the application;
enabling the writing of the patch into at least one address location associated with the file segment;
enabling the marking of the at least one address location that includes the patch as an authoritative section;
receiving a section of the streamed application from the server; and
if at least a portion of the section of the streamed application is to be written into the authoritative section, prohibiting the writing of that portion of the streamed application.

20. An apparatus for managing a streaming of an application, comprising:
a means for receiving a patch associated with the application;
a means for writing the patch into at least one address location associated with the file segment;
a means for marking the at least one address location that includes the patch as an authoritative section;
a means for receiving a section of the streamed application; and
if at least a portion of the section of the streamed application is to be written into the authoritative section, a means for prohibiting the writing of that portion of the streamed application.
